(19) United States
(12) Patent Application Publication
(10) Pub. No.: US 2009/0165662 A1
(43) Pub. Date: Jul. 2, 2009

(54) BRIDGE MANDRELS FOR ANILOX AND PRINT ROLLER APPLICATIONS AND TECHNIQUES FOR MAKING THEM

(75) Inventor: John E. Ritchie, Nashua, NH (US)

Correspondence Address: Vern Maine & Associates, 100 MAIN STREET, P O BOX 3445, NASHUA, NH, 03061-3445, US

(73) Assignee: NIM-COR, INC., Nashua, NH (US)

(21) Appl. No.: 12/347,200

(22) Filed: Dec. 31, 2008

Related U.S. Application Data
(60) Provisional application No. 61/017,943, filed on Dec. 31, 2007.

(51) Int. Cl. B41F 13/10; B21D 53/00

(52) U.S. Cl. 101/376; 29/890.1; 101/375; 29/895.32

(57) ABSTRACT

A bridge mandrel for use on a printing press, an example of which includes making an inner tube laid up with a compressible foam layer between wound glass fiber layers, an outer tube wound with carbon fiber, steel end caps, and a pneumatic system for delivering air to the surface of the completed mandrel; assembling these parts into a hollow bridge mandrel assembly; injecting liquid expanding foam into it as an intermediate component; and finishing the surface of the outer tube. The outer tube is made from tube stock laid up over a peel ply wrapped on a forming mandrel, and cut to length. Another example of the invention includes a bridge sleeve comprising a composite layup of glass, compressible foam, glass, and carbon fiber, the ends of which are sealed from chemical exposure by end caps.

### RELATED APPLICATIONS

This application relates and claims priority to pending U.S. application Ser. No. 61/017,943, filed Dec. 31, 2007.

### BACKGROUND OF THE INVENTION

The prior art of bridge mandrels for anilox and print rollers for printing presses is replete with disclosures of built up, wound or layup roller technology depending on using a core tube and laying up by various means the required layers and thicknesses of various materials appropriate to the final structure.

Bridge layers have been applied by using liquid expandable foam over a core in a mold, and thereafter milling the molded foam to a suitable surface profile and laying up the outer tube or layer on the surface of the foam. Bridge layers have been applied to the core tube by the use of extruders prior to applying the outermost layers.

Other methods are known and practiced in this field of art, and references on the subject are numerous, but none are known to the Applicant to teach the novel bridge mandrels and techniques for making them here disclosed.

### SUMMARY OF THE INVENTION

The invention extends to anilox and print roller structures for use on printing presses, and for methods for making them. In one aspect of the invention, an inner tube and a carbon fiber outer tube are constructed, assembled to prefabricated end caps for correct relative positioning, any required plumbing or other internally routed systems or components such as pneumatic lines and fittings are installed, and a liquid foam is injected into the space between the tubes, expanding and filling the space and solidifying as an open cell foam layer to complete the composite roller assembly.

In another aspect of the invention, there is provided a method for making a bridge mandrel consisting of making an inner tube suitable to the purpose, making an outer tube suitable to the purpose, and making end caps configured to cap the ends of the inner tube and outer tube and hold them in a coaxial relationship so as to define a cavity within. The inner tube, outer tube and end caps are assembled into the form of a hollow bridge mandrel assembly, and then liquid expanding foam is disposed in the cavity, where it is allowed to expand and cure so as to fill the cavity.

In related aspects, in no particular order, the invention extends but is not limited to finishing the surface of the composite bridge mandrel assembly to the desired diameter. The outer tube may include carbon fibers, the method for making an outer tube may include applying peel ply to an outer tube forming mandrel before applying tube materials to form tube stock. The outer tube may be cut from the tube stock. The peel ply may be removed from the inner diameter surface of the outer tube so that it is ready for bonding to the foam that will be injected into the cavity.

In further related aspects, the invention includes but is not limited to kitting of the components of a pneumatic system for the bridge mandrel, the assembling of the inner tube, outer tube, end caps and the components of the pneumatic system into a hollow bridge mandrel assembly for foam injection, where the pneumatic system components installed within the cavity are encased in place by the expanding foam as it cures. The inner tube construction may include a compressible foam layer component.

Examples of the structures and methodologies are explained in more detail below.

### BRIEF DESCRIPTION OF THE DRAWINGS

FIG. 1 is a flow chart of the steps of one embodiment for making a bridge mandrel of the invention.

FIG. 2 is a longitudinal cross section view of one embodiment of a bridge mandrel according to the invention, illustrating an inner tube and an outer carbon fiber tube secured in coaxial relationship by end caps, with pneumatic system components installed.

FIG. 3 is a partial, axial cross section showing the buildup of layers according to the method of the invention, from the inner tube through to the carbon fiber outer tube.

### DETAILED DESCRIPTION OF THE INVENTION

The invention is susceptible of several embodiments. What is described here is intended to be illustrative but not exhaustive of the scope of the invention. It should be noted that the curing times and temperatures recited throughout, including in the claims, are intended to be indicative of working embodiments. It will be clear to those skilled in the art, and the claims are intended to be interpreted to mean such amount of time and temperature as will be effective in curing the materials used.

In one embodiment of a bridge mandrel structure, an inner or core tube of relatively smaller diameter and an outer tube of larger diameter, either or both of which may or may not incorporate carbon fiber material, are fabricated to the desired cross section dimensions and length. A matching set of two end caps are fabricated of suitable material, preferrable including central bores for axially mounting the completed structure, and any useful additional service holes or structural provisions required to support internal subsystems or connections through either or both end caps to the internal subsystems for passing mechanical motion, fluid flow or electrical power or signals in or out of the bridge mandrel interior. The tubes may likewise be further configured with structure, holes or passageways, fittings of any type required in support of or for servicing subsystems or special functions incorporated into the bridge mandrel design. The core and outer tube set is then assembled to the matching set of end caps with suitable coaxial and rotational alignment of the core and outer tubes, and with suitable rotational alignment of the end caps with respect to each other and to the tubes if necessary, with internal pneumatic, electric or other type lines and fittings connected as required.

The outer surface of the core tube and the inner surface of the outer tube, as well as the interior side surfaces of the end caps, may be treated or otherwise specially prepared to accept and adhere to a foam layer applied as described below.

When these rigid structural components are assembled with assurance that the internal elements are all properly located and connected, a liquid expandable foam is injected through at least one port in one end cap into the interior space between the tubes. The liquid foam is deposited into the interior space in a quantity and manner that assures the foam will expand and fill the entire volume of space, enclosing and encapsulating all internal tubes, wires, fittings and fixtures so as to form a composite roller assembly absent of internal voids that might present weight, balance, expansion, weak spots, flexure, or other undesirable problems with a finished bridge mandrel.

The liquid foam may be injected through one or more nozzles inserted through one or more ports in one or both end caps and monitored for expansion extending out one or more ports of one or both end caps. The nozzle position within the interior space or volume of the bridge mandrel may be varied with foam flow or time so as to provide a suitable or uniform distribution of liquid foam within the interior space. The liquid foam may be dispensed at a rate related to its curing time. The total amount of liquid foam, its rate of expansion, its maximum ratio of expanded volume to liquid volume, its pressure/volume characteristics during expansion and curing, its curing time and other related characteristics of the liquid foam and cured foam material may be pre-calculated or otherwise taken into account in conducting this step of the bridge mandrel construction. Any of these characteristics of the liquid foam material may be customized by suitable chemistry to facilitate the injection process.

The following detailed description and reference to the figures is merely one embodiment of the invention, for making a bridge mandrel.

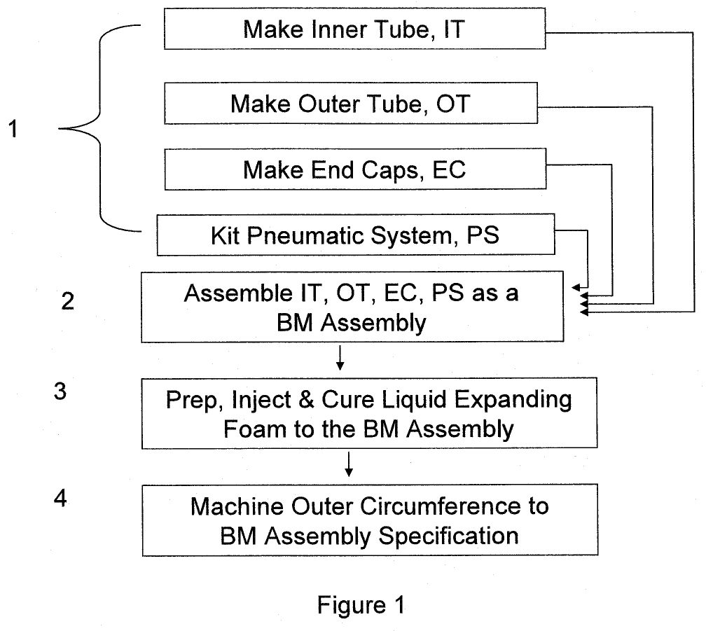

FIGS. 1-3 illustrate the steps of one embodiment of the invention, a method for making a bridge mandrel. Referring to FIG. 1 in particular, the illustrated method includes the basic steps:

(1) making the inner tube 10 and outer tube 30 and the end caps 50 for a bridge mandrel 100 and kitting the components of a pneumatic system 40 to be incorporated into the bridge mandrel;

(2) Assembling the inner tube 10, outer tube 30, end caps 50 and pneumatic system 40 as a bridge mandrel assembly;

(3) Preparing, injecting and curing liquid expanding foam into the bridge mandrel assembly thereby creating expanded foam layer 20; and

(4) machining the outer circumference of the bridge mandrel to the desired specification.

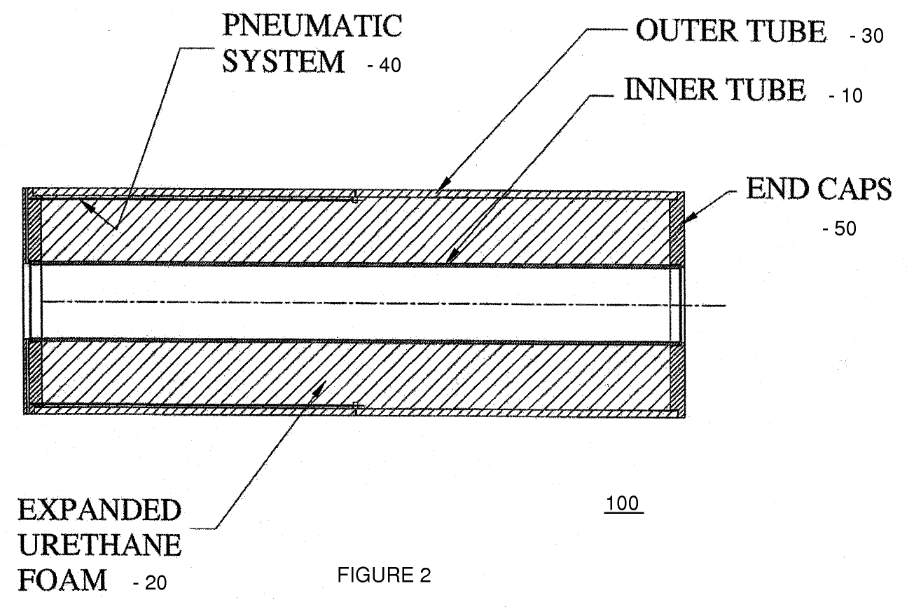

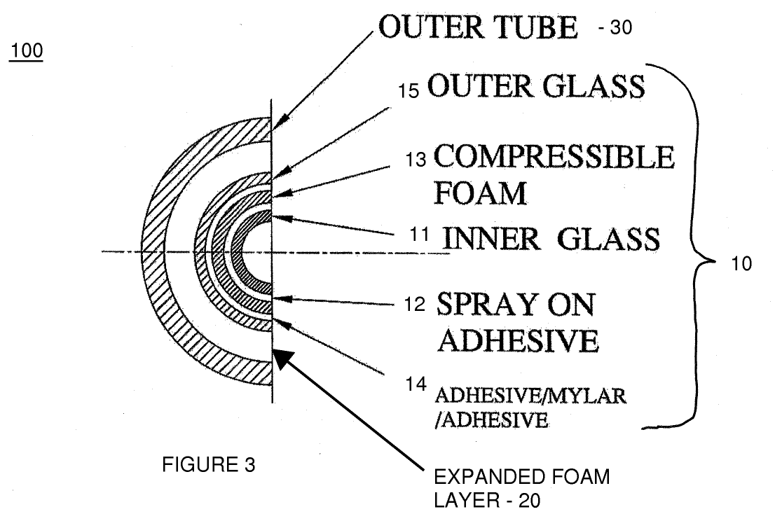

Referring to FIGS. 2 and 3, the orientation of the principal components of a finished bridge mandrel of this embodiment are disclosed. Referring in particular to FIG. 3, the inner tube is diagrammatically enlarged to disclose the component parts of inner tube 10; specifically: inner glass layer 11, spray on adhesive layer 12, compressible foam layer 13, adhesive/mylar/adhesive layer 14, and outer glass layer 15. Expanded foam layer 20 and outer tube 30 are illustrated in their respective positions outboard of inner tube 10. Referring to FIG. 2 specifically, pneumatic system 40, consisting of airways in the end caps 50 connected by air tubes to nozzle fittings installed in the outer tube 30 are disclosed, with the tubing encased by the cured foam of layer 20.

A more detailed embodiment is explained below:

### Inner Tube

Referring generally to the figures, an inner tube or core tube for a bridge mandrel is made as follows. Using a precision ground steel forming mandrel for the layup: first filament wind glass fiber & epoxy resin such as Epon 862/Lindride 6 onto the mandrel, alternating at ±8° to ±87° to normal to the mandral axis, back and forth along the length of the forming mandrel to provide a 0.02 inch thick buildup on the forming mandrel.

There are at least three factors relating to selecting the angle at which the glass fibers are wound for making the inner tube; shrinkage, bandwidth & expandability, and hoop strength. A higher wind angle, resulting in fewer turns per unit length, helps minimize shrinkage in the hoop direction. It is also easier to control the winding band width with higher wind angles which facilitates better process control. And significantly, higher wind angles increase hoop strength and hoop stiffness and thereby restrict the expandability of the inner tube. The converse is also true.

The minimum and maximum practical wind angles are ±8° & ±87°. The plus and minus indicators signify the direction of wind as from left to right or from right to left. In lieu of knowing exactly what diameter to make the mandrel so that the cured part has the correct internal diameter after cure there is some latitude for experimenting with the wind angles to control shrinkage during cure and thereby the specific internal diameter. One could start from a base angle of ±45° and vary the wind angles from there depending on test results. The following combinations have been used with varying success: ±20°/±50°, ±45°, or ±30°/±60°.

The glass layer is then over wrapped with peel ply, a commonly available material used in the aerospace and other industries, that when peeled off later helps to prepare the surface of the glass layer for better adhesion to the next layer of the layup. The peel ply is then overwrapped with shrink film, and the inner tube is suspended by one end and cured in an oven for 3 hours at 250° F., then removed from the oven and allowed to cool.

The shrink wrap and the peel ply are removed. The peel ply has provided a bondable surface without secondary processing. A spray-on adhesive such as 3M Super 77 brand is applied to the outer surface of the glass tube, and a 4 inch strip of compressible urethane foam is wound or wrapped at an angle to cover the full length of the tube.

A 4 inch wide strip of hot melt adhesive/mylar/adhesive is then wound onto the assembly. This is followed by filament winding glass fiber and epoxy resin such as Epon 862/Lindride 6, at a ±45° degree winding angle back and forth over the length of the tube to achieve a desired thickness of glass/epoxy top surface.

A layer of peel ply is then wound over the glass/epoxy layer and shrink film applied for integrity while the assembly is cured in an oven for 3 hour at 225° F. or as required. The tube is then removed, allowed to cool, and the shrink film and peel ply removed, exposing the cured glass/epoxy layer. The finished inner tube is removed from the forming mandrel.

### Outer Tube

Because of the mechanics of wet filament winding with its reversing of direction at each end of the tube as the winding progresses, there is a percentage of tube material or finished tube length at each end of the tube, which is always lost to scrap. This scrap is a higher percentage of the overall material usage for a short tube than for a longer tube, all other things being equal. Making longer tubes where the scrap can be amortized over a long tube makes the waste a much smaller percentage of the overall material used and therefore the raw material yield is significantly better. For this reason, a forming mandrel for making carbon tube stock may be selected to be two, or three or more multiples of the unit length of the desired carbon tube blanks, plus a half tube length or so to be divided about equally on each end for waste.

Peel ply is wound directly on the carbon tube forming mandrel to define and prepare the inner surface of the carbon tube stock. Then wind the carbon fiber over the peel ply to form the carbon fiber tube. Then wind a resin rich layer (with nexus Fabric) if required.

The layup is then covered with shrink film and cured in an oven as required. Thereafter it is removed and allowed to cool. The tube stock is removed from the forming mandrel and the interior side peel ply is removed. The ends are removed and the central portion is cut to the correct tube length. The tube end edges are finished as required.

There may be further detail work done to either or both tubes to accomodate special systems such as the pneumatic system described below.

### End Caps

A pair of end caps is fabricated from steel or other suitable material, with a central bore and any necessary provision for a pneumatic system such as ports for accepting pneumatic fittings. Other and various alternative or additional subsystems and functions may be incorporated into the tube and end cap design. The caps must be configured for accepting and capping the ends of the inner and outer tubes in a coaxial relationship defining an enclosed or interior volume and having at least one filling port in at least one end cap for the later injection of liquid expanding foam.

### Pneumatic System

A pneumatic system to facilitate such functions as air mounting of sleeves upon the finished bridge mandrel, if applicable, is kitted so as to be available for assembly. This includes collecting all fittings and lines that will be incorporated into the assembled bridge mandrel prior to the injection of the liquid expanding foam. While a pneumatic system is called out here, the invention extends to such other bridge mandrel subsystems as may be incorporated now or in the future into a bridge mandrel design to facilitate its usage or otherwise enhance or extend its range of application.

### Assembly

The tubes, typically the outer tube, is prepared as required to accept the necessary pneumatic system fittings. The fittings and tubes are installed as required. The glass fiber inner tube, carbon fiber outer tube and aluminum ends are assembled along with the pneumatic system on an assembly jig and bonded with Hysol EA 9394 or equivalent, and cured as required. The interior volume may be divided by a flexible membrane or interior partition of any sort, into two or more interior chambers, each accessible through a fill port in an end cap, in order to facilitate the next step of foam injection.

### Injection/Expansion/Curing of Liquid Foam

Liquid urethane foam, in this embodiment US Composites 81b or 161b urethane or equivalent, is prepared and poured or injected into the hollow bridge mandrel assembly through one or both end caps and allowed to set up or cure. A membrane or partition dividing the interior cavity into two or more chambers chambers, may require filling individual chambers from respective ports. If a cavity is significantly overfilled with expanding foam it is possible to generate internal pressure. However overfilling the bridge mandrel cavity by only 5% to 10% of the amount of liquid foam calculated to result in an expanded volume equal to the enclosed cavity volume is likely to generate only low pressures of the order of 5 psi, not normally excessive for this type of structure. It being desirable to avoid voids, a slight amount of overfilling is desirable.

Temperature buildup during the curing of the foam is not very high, normally a maximum of 150° F. The ability to mix and inject the foam before the foam starts to expand is important, as will be readily understood by those skilled in the art. The mix ratio of the two part liquid foam is not overly sensitive, however complete mixing is important in order to achieve a uniform distribution and density of the foam portion of the finished assembly.

### Final Machining

The filled and cured bridge mandrel assembly is then mounted on a precision machining mandrel and the outer diameter and surface finish is machined as required. Appropriate quality control checks and steps assumed to have been conducted during and after the fabrication process, the bridge mandrel is now ready for use.

Aspects of the technology offer numerous embodiments and variations within the scope of the invention. For example, a second embodiment of the invention is directed to a bridge mandrel or bridge sleeve useful for anilox roller applications. This embodiment and others like it utilizes a layup process on a forming mandrel, from start to finish, that yields a composite structure with a compressible foam layer and a carbon fiber outer layer. The composite bridge sleeve with compressible foam layer is described below through the steps of the layup process for making it:
a. Wind glass fiber & epoxy resin on a precision ground forming mandrel. Use, for example, Epon 862/Lindride 6 or equivalent. Wind the materials at ±8° to ±87° to provide a 0.02 to 0.04 inch thick buildup of glass fiber layer on the mandrel.
b. Overwrap the glass fiber layer with peel ply as elsewhere described.
c. Overwrap the peel ply layer with shrink film as elsewhere described.
d. Cure the layup in an oven for 3 hours at 250° F. or as otherwise required.
e. Remove the cured layup from the oven and cool.
f. Remove the shrink wrap and peel ply. The peel ply, when removed leaves a bondable surface finish that does not need secondary processing to prepare the surface for bonding.
g. Spray 3MSuper 77 spray on contact adhesive or equivalent onto the outside of the glass tube and to the inside surface of a 7/3/50 4″ wide strip of compressible foam 7 mil mylar carrier, 50 mils orange(urethane) foam wrap material or equivalent. The material need not have a mylar carrier; the compressible foam provides the required functionality.
h. Apply the foam wrap material uniformally over the glass tube.
i. Wind 5/10/5 4″ wide strip hot melt adhesive/mylar/hot melt adhesive or similar over the compressible foam layer.
j. Wind glass fiber & epoxy resin (Epon 862/Lindride 6 or equivalent) at ±45° over the mylar/adhesive layer of step 9 to achieve desired thickness.
k. Wind carbon fiber epoxy over the glass fiber layer to form a carbon fiber layer.
l. Cure the layup in an oven at 225° F. as required.
m. Remove from the oven and machine to the desired final diameter and surface finish.

The description of the second embodiment above is intended to illustrate this aspect of the invention but is not exhaustive of its scope. The process for constructing the sleeve is purely a layup process that grows the diameter of a singular structure in composite layers. It does not require the joining of two separate structures such as the addition of a metallic sleeve over a core layup. The process further incorporates a compressible foam layer at a location in the layup order facilitating later mounting of the sleeve on a suitable shaft. The process also incorporates the use of peel ply in a manner that eliminates the need for a special surface treatment for bonding of a subsequent layer. The process and resulting composite or laminate structure terminates with an outer layer containing carbon fiber for all of its attendant benefits. There may be a further surface treatment or typical layer suitable for a specific application. The processes of the two embodiments discussed above are markedly different, but the resulting structures have similarities. The second embodiment structure resembles the FIG. 3 first embodiment without the expanded foam layer.

It should be noted that end caps for the second embodiment are not strictly necessary from a structural standpoint, but are preferred for protecting the exposed edges of the bonded layers from exposure to chemicals associated with usage. End caps of steel or epoxy or other chemically resistant materials may be configured and/or applied to the sleeve ends so as to seal the exposed edges of the sleeve layers. Steel end caps may be fabricated and applied adhesively or otherwise. Epoxy or other curable liquid material end caps may be applied by any suitable means including by dipping or coating the sleeve ends with the material in liquid form and thereafter curing it. Other suitable means for sealing the sleeve ends are within the scope of the invention. Provisions for end cap fittings such as for pneumatic systems can be accomodated during or after application of the end caps.

As in the bridge mandrel described above, there may be a pneumatic system or other subsystem integrated into the design; such as air channels by which air flow can be directed through the sleeve ends or end caps or from grooves or air ports on the shaft upon which the sleeve is mounted, to the sleeve surface. The incorporation of other types of subsystems as described elsewhere herein is anticipated and considered within the scope of the invention.

Other and various embodiments of the invention are within the scope of or equivalent to the appended claims.

For example, there is within the scope of the invention a method for making a bridge mandrel comprising: making an inner tube suitable to the purpose, which may be made of glass fibers and epoxy and incorporate adhesive layers and compressible foam; making an outer tube suitable to the purpose, which may be made of or include carbon fibers; making end caps configured to cap the ends of the inner tube and outer tube and hold them in a coaxial relationship so as to form a hollow bridge mandrel assembly. The end caps may be made of aluminum or other moldable and/or machinable materials and may incorporate air passageways and provisions for fittings necessary for connecting a pneumatic source to nozzles or air outlets in the outer tube via an internal pneumatic system. The invention is adaptable to incorporating other fluid flow, electrical or electronic systems, fittings, batteries, sensors, actuators and related components, and end cap or shaft end terminations, junctions, and connections for fluid flow, electrical power, or wired or wireless data communications to and from the bridge mandrel, into the end cap and tube design and fabrication.

The method further requires assembling the inner tube, outer tube, end caps and additional components into a hollow bridge mandrel assembly, which may include the use of a jig or other alignment tools, and adhesives or other fastening means for securing the tubes to the end caps; injecting or pouring or otherwise inserting liquid expanding foam into the interior of the hollow assembly in a controlled manner calculated to fill the interior with foam when it is fully expanded and cured; allowing the liquid expanding foam to expand and cure so as to fill the interior of the hollow bridge mandrel assembly, which may include allowing excess foam to be emitted or extruded from the interior of the assembly through one or more ports during the curing process; and finishing the surface of the bridge mandrel assembly to the desired diameter and surface finish.

As another example of the invention, there is a method for making an outer tube that includes: applying peel ply to an outer tube forming mandrel and winding or otherwise applying tube materials which may include materials as described in other embodiments herein, and may include carbon fiber, over the peel ply so as to form tube stock; removing the tube stock from the forming mandrel; and removing the peel ply from the inner diameter surface of the tube stock so that the inner diameter surface is ready for bonding to the foam core.

As still another example of the invention, the method may include kitting or collecting the pneumatic components of a pneumatic system for the bridge mandrel, and assembling the inner tube, outer tube, end caps and pneumatic components into a hollow bridge mandrel assembly.

As yet further examples, the invention includes bridge mandrels and parts made by any of the methods described or claimed herein.

Other examples and advantages will be apparent to those skilled in the art from the description, drawings, and appended claims.

I claim:

1. A method for making a bridge mandrel comprising:
making an inner tube suitable to the purpose;
making an outer tube suitable to the purpose;
making end caps configured to cap the ends of the inner tube and outer tube and hold them in a coaxial relationship so as to form a hollow bridge mandrel assembly;
assembling the inner tube, outer tube and end caps into a said hollow bridge mandrel assembly;
injecting liquid expanding foam into the interior of the hollow assembly; and
allowing the liquid expanding foam to expand and cure so as to fill the interior of the hollow bridge mandrel assembly.

2. The method of claim 1, further comprising:
finishing the surface of the bridge mandrel assembly to the desired diameter.

3. The method of claim 1, said outer tube comprising carbon fiber.

4. The method of claim 1, said making an outer tube comprising;
applying peel ply to an outer tube forming mandrel;
applying tube materials over said peel ply so as to form tube stock;
removing said tube stock from said forming mandrel;
cutting an outer tube from said tube stock; and
removing said peel ply from the inner diameter surface of said outer tube whereby it is ready for bonding to said foam.

5. The method of claim 1, comprising:
kitting components of a pneumatic system for said bridge mandrel, said assembling the inner tube, outer tube and end caps comprising assembling the inner tube, outer tube, end caps and the components of the pneumatic system into a said hollow bridge mandrel assembly.

6. A bridge mandrel made by the method of claim 1.

7. The bridge mandrel of claim 6, said inner tube comprising a compressible foam component.

8. The bridge mandrel of claim 7, said inner tube further comprising in order an inner glass layer, a spray on adhesive layer, said compressible foam layer, an adhesive/mylar/adhesive layer, and an outer glass layer.

9. A method for making an outer tube for a bridge mandrel comprising;
applying peel ply to an outer tube forming mandrel;
applying tube materials over said peel ply so as to form tube stock;
removing said tube stock from said forming mandrel;
cutting an outer tube from said tube stock; and
removing said peel ply from the inner diameter surface of said outer tube whereby it is ready for bonding to foam.

10. A bridge mandrel comprising:
an inner tube;
an outer tube of relatively larger diameter than the inner tube;
end caps by which the inner tube and outer tube are held in a co-axial relationship defining an internal cavity between the inner tube and the outer tube; and
an intermediate layer of expanded, open cell foam disposed in the cavity.

11. The bridge mandrel of claim 10, said inner tube comprising an inner glass layer, a spray on adhesive layer, a compressible foam layer, an adhesive/mylar/adhesive layer, and an outer glass layer.

12. The bridge mandrel of claim 10, incorporating a pneumatic system for supplying air flow through at least one end cap to the outer surface.

13. The bridge mandrel of claim 10, said outer tube comprising carbon fiber.

14. A method for making a bridge sleeve comprising:
winding glass fiber & epoxy resin on a precision ground forming mandrel within a range of ±8° to ±87° so as to provide a 0.02 to 0.04 inch thick layer on the mandrel;
overwrapping the glass fiber layer with peel ply;
overwrapping the peel ply layer with shrink film, the glass fiber layer, peel ply and shrink film comprising a layup;
curing the layup in an oven for 3 hours at 250° F. or such time and temperature as the selected materials require;
removing the cured layup from the oven and cool;
removing the shrink wrap and peel ply thereby exposing a glass tube;
spraying a contact adhesive onto the outside of the glass tube and to the inside surface of a strip of compressible foam on a mylar carrier;
applying the foam wrap material uniformally over the glass tube;
winding a strip of hot melt adhesive/mylar/hot melt adhesive material over the compressible foam layer;
winding glass fiber & epoxy resin over the adhesive material to a desired thickness;
winding carbon fiber epoxy over the glass fiber layer to form a carbon fiber layer; and
curing the carbon fiber layup in an oven at a time and temperature suitable for the materials used.

15. The method of claim 14, further comprising:
machining the tube surface to the desired final diameter and surface finish.

16. A bridge sleeve made by the method of claim 14.

17. The bridge sleeve of claim 16, further comprising chemically resistant end caps applied to the sleeve ends so as to seal the exposed edges of the layers of the sleeve.

18. A bridge sleeve comprising in order from inner diameter to outer diameter a layer of wound glass fiber and epoxy resin, a layer of adhesive, a layer of compressible foam, a layer of adhesive/mylar/adhesive, a layer of glass fiber and epoxy resin, and a layer of carbon fiber.

19. The bridge sleeve of claim 18, further comprising end caps by which exposed edges of the layers are sealed.

20. The bridge sleeve of claim 19, further comprising a pneumatic system for delivering air to the outer surface of the sleeve.
